(19) United States
(12) Patent Application Publication
(10) Pub. No.: US 2015/0357626 A1
(43) Pub. Date: Dec. 10, 2015

(54) POROUS SEMI-SOLID ELECTRODE AND METHODS OF MANUFACTURING THE SAME

(71) Applicant: 24M Technologies, Inc., Cambridge, MA (US)

(72) Inventors: Richard HOLMAN, Wellesley, MA (US); Naoki OTA, Lexington, MA (US)

(21) Appl. No.: 14/732,298

(22) Filed: Jun. 5, 2015

Related U.S. Application Data
(60) Provisional application No. 62/008,083, filed on Jun. 5, 2014.

(51) Int. Cl. H01M 4/04; H01M 10/0565; H01M 10/0525; H01M 4/13

(52) U.S. Cl. CPC H01M 4/0485; H01M 4/13; H01M 10/0565; H01M 10/0525; H01M 4/0471; H01M 2004/021

(57) ABSTRACT

Embodiments described herein relate generally to electrochemical cells having porous semi-solid electrodes and in particular, semi-solid electrodes that include electrolyte filled meso-pores such that the semi-solid electrodes have higher electronic conductivity. In some embodiments, a method of preparing a porous semi-solid electrode includes combining an active material with an electrolyte to form an intermediate material, the electrolyte including a liquid component and a pore former. A conductive material is combined with the intermediate material to form a semi-solid electrode material. The pore former is then caused to liquefy to form a porous semi-solid electrode. In some embodiments, the pore former is maintained at a temperature below a dissolution temperature and/or a melting temperature of the pore former prior to causing the pore former to liquefy. In some embodiments, the pore former can be ethylene carbonate (“EC”).

### CROSS REFERENCE TO RELATED APPLICATIONS

This application claims priority to and the benefit of U.S. Provisional Application No. 62/008,083, filed Jun. 5, 2014 and titled “Porous Semi-Solid Electrode and Methods of Manufacturing the Same,” the disclosure of which is hereby incorporated by reference in its entirety.

### BACKGROUND

Embodiments described herein relate generally to electrochemical cells having porous semi-solid electrodes and in particular, semi-solid electrodes that include a plurality of electrolyte filled meso-pores such that the semi-solid electrodes have higher conductivity.

Batteries are typically constructed of solid electrodes, separators, electrolyte, and ancillary components such as, for example, packaging, thermal management, cell balancing, consolidation of electrical current carriers into terminals, and/or other such components. The electrodes typically include active materials, conductive materials, binders and other additives.

As the demand for batteries having better electrical performance, for example, higher charge capacity, energy density, conductivity, and rate capabilities increases, new electrode designs are needed to meet these criteria. One way of improving the electrical performance of the electrodes is to increase the thickness of the electrode, for example, thickness of greater than about 200 μm. Known conventional electrodes cannot be made thicker than 200 μm. This is because thick conventional electrodes have very high impedance. Although, the thicker conventional electrodes can have higher energy density and charge capacity, the higher impedance reduces the rate capability of the electrode, such that the electrodes become unusable. Furthermore, such thick conventional electrodes can undergo cracking and delamination from the current collectors during manufacturing, for example, during the drying or “jellyroll” assembling process. Semi-solid electrodes can however be made much thicker, for example, about 250 μm or greater, such that, the semi-solid electrodes have a higher charge capacity and energy density, while having a sufficiently high conductivity to maintain a desired rate capability.

One way of lowering the impedance of electrodes is to provide rapid diffusion paths through the thickness of the electrode. This can be achieved by creating secondary porous structures and/or networks that provide a large area, low tortuosity (and thus high conductivity) path for ions to reach the depths of the electrode without the voltage drop associated with the long, tortuous diffusion path through the primary pore structure typical of Li-ion electrodes. As an example, this can be accomplished via structured electrodes such as porous carbon, carbon foam, etc. This results in faster and more efficient ion transfer and lower impedance. It would be of great benefit to realize thicker electrodes for use in electrochemical cells such as, for example, lithium-ion batteries that have engineered secondary porous structures, such that the electrodes can have higher charge capacity, higher energy density, broader rate capability, low impedance, and longer cycle life.

Thus, it is an enduring goal of energy storage systems development to develop new electrochemical batteries and electrodes that have increased energy density, charge capacity, lower impedance and improved overall performance.

### SUMMARY

Embodiments described herein relate generally to electrochemical cells having porous semi-solid electrodes and in particular, semi-solid electrodes that include electrolyte filled meso-pores, where meso-pores are defined as being large compared to the inherent microporosity typically present in the electrodes and to the characteristic active particle size in the electrode, such that the semi-solid electrodes have higher average ionic conductivity. In some embodiments, a method of preparing a porous semi-solid electrode includes combining an active material with an electrolyte to form an intermediate material, the electrolyte including a liquid component and a pore former. A conductive material is combined with the intermediate material to form a semi-solid electrode material. The pore former is then caused to liquefy (e.g., to melt or to dissolve) to form a porous (e.g., meso-porous) semi-solid electrode. In some embodiments, the pore former is maintained at a temperature below a dissolution temperature and/or a melting temperature of the pore former (e.g., at a temperature of less than about 25 degrees Celsius) prior to causing the pore former to liquefy. In some embodiments, the pore former can be ethylene carbonate (“EC”). In some embodiments, the pore former can be a polymer (e.g., polyethylene oxide or a derivative thereof) that is soluble in the electrolyte. In some embodiments, the pore former can be a salt, or a metal powder (e.g., lithium metal powder). In some embodiments, the pore former comprises a plurality of particles. Prior to being liquefied, a quantity of the pore former can be in a range of about 5% to about 60% by volume of the electrolyte, or in a range of about 5% to about 60% by volume of the semi-solid electrode. In some embodiments, the liquefying occurs via dissolution of the pore former into the semi-solid electrode (or a component thereof) via diffusion. In some embodiments, the method includes heating the pore former (e.g., at a temperature of greater than about 37 degrees Celsius) to dissolve the pore former in the semi-solid electrode to form the porous semi-solid electrode.

In some embodiments, a method of preparing a porous semi-solid electrode includes combining an active material with an electrolyte to form an intermediate material. A conductive material is combined with the intermediate material to form a semi-solid electrode material. A solid electrolyte component is combined with the semi-solid electrode material. The semi-solid electrode material is formed into a semi-solid electrode. The solid electrolyte component is liquefied to form a porous semi-solid electrode. In some embodiments, the solid electrolyte component is combined with the semi-solid electrode material while maintaining the semi-solid electrode material at a temperature that is below a dissolution temperature and/or a melting temperature of the solid electrolyte component (e.g., at a temperature of less than about 25 degrees Celsius). In some embodiments, the solid electrolyte component can be ethylene carbonate (“EC”). In some embodiments, the solid electrolyte component can be a polymer (e.g., polyethylene oxide or a derivative thereof), a salt, or a lithium metal powder. In some embodiments, the solid electrolyte component comprises a plurality of particles. In some embodiments, the liquefying occurs via dissolution of the solid electrolyte component into the semi-solid electrode (or a component thereof) via diffusion. In some embodiments, the method includes heating the solid electrolyte component (e.g., at a temperature of greater than about 37 degrees Celsius) to dissolve the solid electrolyte component to form the porous semi-solid electrode.

In some embodiments, a semi-solid electrode includes about 20% to about 80% by volume of an active material, about 0% to about 25% by volume of a conductive material, and about 20% to about 70% by volume of an electrolyte solution, such that the semi-solid electrode includes a plurality of engineered pores (e.g., meso-pores) defined within the semi-solid electrode. In some embodiments, each of the plurality of pores can be filled with the electrolyte solution and provide a diffusion path for fast ion and/or electron transfer through the semi-solid electrode.

### BRIEF DESCRIPTION OF THE DRAWINGS

FIG. 1 is a schematic illustration of an electrochemical cell according to an embodiment.

FIG. 2A shows a semi-solid cathode included in the electrochemical cell of FIG. 1 that includes a plurality of solid particles dispersed within the semi-solid cathode.

FIG. 2B shows the semi-solid cathode of FIG. 2A with the solid particles dissolved, leaving behind electrolyte filled meso-pores within the semi-solid electrode.

FIG. 3 illustrates a flow diagram showing a method of preparing a porous semi-solid electrode according to an embodiment.

FIG. 4 illustrates a flow diagram showing a method of preparing a porous semi-solid electrode according to an embodiment.

### DETAILED DESCRIPTION

Embodiments described herein relate generally to electrochemical cells having porous semi-solid electrodes and in particular, semi-solid electrodes that include electrolyte filled meso-pores, where meso-pores are defined as being large compared to the inherent microporosity typically present in the electrodes and to the characteristic active particle size in the electrode, such that the semi-solid electrodes have higher average ionic conductivity. In some embodiments, a method of preparing a porous semi-solid electrode includes combining an active material with an electrolyte to form an intermediate material, the electrolyte including a liquid component and a pore former. A conductive material is combined with the intermediate material to form a semi-solid electrode material. The pore former is then caused to liquefy (e.g., to melt or to dissolve) to form a porous (e.g., meso-porous) semi-solid electrode. In some embodiments, the pore former is maintained at a temperature below a dissolution temperature and/or a melting temperature of the pore former (e.g., at a temperature of less than about 25 degrees Celsius) prior to causing the pore former to liquefy. In some embodiments, the pore former can be ethylene carbonate (“EC”). In some embodiments, the pore former can be a polymer (e.g., polyethylene oxide or a derivative thereof), a salt, or a lithium metal powder. In some embodiments, the pore former comprises a plurality of solid particles. Prior to being liquefied/dissolved, a quantity of the pore former can be in a range of about 5% to about 60% by volume of the electrolyte, or in a range of about 5% to about 60% by volume of the semi-solid electrode. In some embodiments, the liquefying occurs via dissolution of the pore former into the semi-solid electrode (or a component thereof) via diffusion. In some embodiments, the method includes heating the pore former (e.g., at a temperature of greater than about 37 degrees Celsius) to dissolve the pore former in the semi-solid electrode to form the porous semi-solid electrode.

In some embodiments, a method of preparing a porous semi-solid electrode includes combining an active material with an electrolyte to form an intermediate material. A conductive material is combined with the intermediate material to form a semi-solid electrode material. A solid electrolyte component is combined with the semi-solid electrode material. The semi-solid electrode material is formed into a semi-solid electrode. The solid electrolyte component is liquefied/dissolved to form a porous semi-solid electrode. In some embodiments, the solid electrolyte component is combined with the semi-solid electrode material while maintaining the semi-solid electrode material at a temperature that is below a dissolution temperature and/or a melting temperature of the solid electrolyte component (e.g., at a temperature of less than about 25 degrees Celsius). In some embodiments, the solid electrolyte component can be ethylene carbonate (“EC”). In some embodiments, the solid electrolyte component can be a polymer (e.g., polyethylene oxide or a derivative thereof), a salt, or a lithium metal powder. In some embodiments, the solid electrolyte component comprises a plurality of solid particles. In some embodiments, the liquefying occurs via dissolution of the solid electrolyte component into the semi-solid electrode (or a component thereof) via diffusion. In some embodiments, the method includes heating the solid electrolyte component (e.g., at a temperature of greater than about 37 degrees Celsius) to dissolve the solid electrolyte component to form the porous semi-solid electrode.

In some embodiments, a semi-solid electrode includes about 20% to about 80% by volume of an active material, about 0% to about 25% by volume of a conductive material, and about 20% to about 70% by volume of an electrolyte solution, such that the semi-solid electrode includes a plurality of engineered pores (e.g., meso-pores) defined within the semi-solid electrode. In some embodiments, each of the plurality of pores can be filled with the electrolyte solution and provide a diffusion path for fast ion and/or electron transfer through the semi-solid electrode.

Consumer electronic batteries have gradually increased in energy density with the progress of lithium-ion battery technology. The stored energy or charge capacity of a manufactured battery is a function of: (1) the inherent charge capacity of the active material (mAh/g), (2) the volume of the electrodes (cm³) (i.e., the product of the electrode thickness, electrode area, and number of layers (stacks)), and (3) the loading of active material in the electrode media (e.g., grams of active material per cm³ of electrode media). Therefore, to enhance commercial appeal (e.g., increased energy density and decreased cost), it is generally desirable to increase the areal charge capacity (mAh/cm²). The areal charge capacity can be increased, for example, by utilizing active materials that have a higher inherent charge capacity, increasing relative percentage of active charge storing material (i.e., “loading”) in the overall electrode formulation, and/or increasing the relative percentage of electrode material used in any given battery form factor. Said another way, increasing the ratio of active charge storing components (e.g., the electrodes) to inactive components (e.g., the separators and current collectors), increases the overall energy density of the battery by eliminating or reducing components that are not contributing to the overall performance of the battery. One way to accomplish increasing the areal charge capacity, and therefore reducing the relative percentage of inactive components, is by increasing the thickness of the electrodes.

Semi-solid electrodes described herein can be made: (i) thicker (e.g., greater than about 250 μm-up to about 2,000 μm or even greater) due to the reduced tortuosity and higher electronic conductivity of the semi-solid electrode, (ii) with higher loadings of active materials, and (iii) with a simplified manufacturing process utilizing less equipment. These semi-solid electrodes can be formed in fixed or flowable configurations and decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes.

Since the semi-solid electrodes described herein can be made substantially thicker than conventional electrodes, the ratio of active materials (i.e., the semi-solid cathode and/or anode) to inactive materials (i.e. the current collector and separator) can be much higher in a battery formed from electrochemical cell stacks that include semi-solid electrodes relative to a similar battery formed from electrochemical cell stacks that include conventional electrodes. This substantially increases the overall charge capacity and energy density of a battery that includes the semi-solid electrodes described herein. Examples of electrochemical cells utilizing thick semi-solid electrodes and various formulations thereof are described in U.S. Pat. No. 8,993,159 (also referred to as “the '159 patent”), issued Mar. 31, 2015, entitled “Semi-Solid Electrodes Having High Rate Capability,” and U.S. Patent Application Publication No. 2014-0315097 (also referred to as “the '097 publication), published Oct. 23, 2014, entitled “Asymmetric Battery Having a Semi-Solid Cathode and High Energy Density Anode,” the entire disclosures of which are hereby incorporated by reference.

One method for improving the ionic conductivity of electrodes is to provide “rapid diffusion paths” through the thickness of the electrode by creating secondary porous structures that provide a large area, low tortuosity path for ions to penetrate into the electrode. This results in an overall lowering of the electrochemical cell's medium to low frequency impedance (lower than 1 kHz) yielding an electrochemical cell that has improved rate capability and, in some cases, longer cycle life. While the semi-solid electrodes described herein have a thickness greater than conventional electrodes, and have lower impedance than what would be expected from a conventional electrode of the same thickness, it would still be of great benefit to introduce an array of pores having a predetermined size and pore density in the semi-solid electrodes to further reduce the impedance of such electrodes and thereby increase the ionic conductivity of the semi-solid electrodes. Such pores can be filled with the liquid electrolyte and provide a multitude of direct “short circuit” diffusion paths that can by pass the tortuosity inherent within the semi-solid electrodes, thereby enhancing the conductivity of the semi-solid electrodes.

In some embodiments, semi-solid electrodes described herein include solid particles, for example, solid ethylene carbonate in fine particulate form dispersed within the semi-solid electrode slurry. The solid particles dissolve in the semi-solid electrode after the semi-solid electrode slurry is formed into the semi-solid electrode, leaving behind a plurality of electrolyte filled meso-pores within the semi-solid electrode. The porous semi-solid electrodes described herein provide several advantages including; (1) a plurality of short circuit diffusion paths throughout the porous semi-solid electrode which substantially reduce the inherent tortuosity and enhance the ionic conductivity of the semi-solid electrodes; (2) ability to control the size of the meso-pores and quantity of the meso-pores in the semi-solid electrode can enable tailoring of the conductivity of the semi-solid electrode; (3) higher charge rate capability and (4) the solid particles used in the semi-solid electrode formulation, for example, ethylene carbonate for forming the meso-pores is also included in the liquid electrolyte used to form the semi-solid electrode. Therefore, there are no negative impacts on the electronic performance of the semi-solid electrode because of the dissolved solid particles.

In some embodiments, the solid particles that are mixed in with the semi-solid slurry can include ion-conductive polymer particles. The ion conductive polymer particles can be soluble or insoluble in the liquid electrolyte. The ion-conductive polymer particles can provide the advantage of easier processability, for example by removing the constraint of controlling the processing time and temperature as is the case with solid ethylene carbonate particles. In some embodiments, the solid particles can include a combination of solid particles, for example solid ethylene carbonate particles and the ion-conductive polymer particles. In some embodiments, the solubility of the solid particles can be modified. For example, the solid particles can be insoluble at one temperature (e.g., room temperature) and soluble at a second temperature (e.g., an operating temperature of the cell). In some embodiments, an additive or coating can be used to modify the solubility of the solid particles. For example, the solid particles can be coated to delay the dissolution or reduce the dissolution rate.

In some embodiments, a semi-solid electrode includes about 20% to about 80% by volume of an active material, about 0% to about 25% by volume of a conductive material, and about 20% to about 70% by volume of a liquid electrolyte, such that the semi-solid electrode includes a plurality of engineered meso-pores formed within the semi-solid electrode by dissolution of solid particles. In some embodiments, each of the plurality of meso-pores can be filled with the liquid electrolyte and provide a diffusion path for fast ion transfer through the semi-solid electrode. In some embodiments, the solid particles can be ethylene carbonate.

In some embodiments, a method of preparing a porous semi-solid electrode includes combining an active material with a liquid electrolyte to form an intermediate material. A conductive material is combined with the intermediate material to form a semi-solid electrode material. Solid particles are mixed with the semi-solid electrode material and the semi-solid electrode material is formed into a semi-solid electrode. The solid particles are then dissolved into, and/or melted within, the semi-solid electrode to form a porous semi-solid electrode. In some embodiments, the solid particles can be ethylene carbonate.

In some embodiments, semi-solid electrode compositions (also referred to herein as “semi-solid suspension” and/or “slurry”) described herein can be mixed in a batch process e.g., with a batch mixer that can include, for example, a high shear mixture, a planetary mixture, a centrifugal planetary mixture, a sigma mixture, a CAM mixture, and/or a roller mixture, with a specific spatial and/or temporal ordering of component addition. In some embodiments, slurry components can be mixed in a continuous process (e.g. in an extruder), with a specific spatial and/or temporal ordering of component addition. Once the slurry components have been properly mixed, solid particles, for example, ethylene carbonate particles, ion conductive polymers, or combinations thereof, can be further mixed with the semi-solid electrode slurry. In some embodiments, the slurry mixing can be performed at a low temperature, for example, lower than about 25 degrees Celsius (e.g., about 5 degrees Celsius) to prevent the solid particles, for example, ethylene carbonate from melting and/or dissolving. Once the semi-solid slurry has been cast into the semi-solid electrode, the temperature can be allowed to increase, for example, greater than about 37 degrees Celsius, to dissolve the solid particles thereby creating meso-pores in the semi-solid electrode.

The mixing and forming of a semi-solid electrode generally includes: (i) raw material conveyance and/or feeding, (ii) mixing, (iii) mixed slurry conveyance, (iv) dispensing and/or extruding, and (v) forming. In some embodiments, multiple steps in the process can be performed at the same time and/or with the same piece of equipment. For example, the mixing and conveyance of the slurry can be performed at the same time with an extruder. Each step in the process can include one or more possible embodiments. For example, each step in the process can be performed manually or by any of a variety of process equipment. Each step can also include one or more sub-processes and, optionally, an inspection step to monitor process quality.

In some embodiments, the process conditions can be selected to produce a prepared slurry having a mixing index of at least about 0.80, at least about 0.90, at least about 0.95, or at least about 0.975. In some embodiments, the process conditions can be selected to produce a prepared slurry having an electronic conductivity of at least about 10⁻⁶ S/cm, at least about 10⁻⁵ S/cm, at least about 10⁻⁴ S/cm, at least about 10⁻³ S/cm, at least about 10⁻² S/cm, at least about 10⁻¹ S/cm, at least about 1 S/cm, or at least about 10 S/cm In some embodiments, the process conditions can be selected to produce a prepared slurry having an apparent viscosity at room temperature of less than about 100,000 Pa-s, less than about 10,000 Pa-s, or less than about 1,000 Pa-s, all at an apparent shear rate of 1,000 s⁻¹. In some embodiments, the process conditions can be selected to produce a prepared slurry having two or more properties as described herein. Examples of systems and methods that can be used for preparing the semi-solid electrode compositions described herein are described in U.S. Patent Application Publication No. 2013-0337319 (also referred to as “the '319 publication”), published Dec. 19, 2013, entitled “Electrochemical Slurry Compositions and Methods for Preparing the Same,” the entire disclosure of which is hereby incorporated by reference.

As used herein, the term “about” and “approximately” generally mean plus or minus 10% of the value stated, e.g., about 250 μm would include 225 μm to 275 μm, about 1,000 μm would include 900 μm to 1,100 μm.

As used herein, the term “semi-solid” refers to a material that is a mixture of liquid and solid phases, for example, such as particle suspension, colloidal suspension, emulsion, gel, or micelle.

As used herein, “dissolution temperature” refers to a temperature at which a given substance (i.e., a “solute”) readily dissolves into a solvent (e.g., a liquid).

As used herein, the terms “conductive carbon network” and “networked carbon” relate to a general qualitative state of an electrode. For example, an electrode with a carbon network (or networked carbon) is such that the carbon particles within the electrode assume an individual particle morphology and arrangement with respect to each other that facilitates electrical contact and electrical conductivity between particles and through the thickness and length of the electrode. Conversely, the term “unnetworked carbon” relates to an electrode wherein the carbon particles either exist as individual particle islands or multi-particle agglomerate islands that may not be sufficiently connected to provide adequate electrical conduction through the electrode.

As used herein, the term “porous semi-solid electrode” refers to a semi-solid electrode that has an array of meso-pores of a predetermined diameter and a predetermined quantity of meso-pores within the semi-solid electrode.

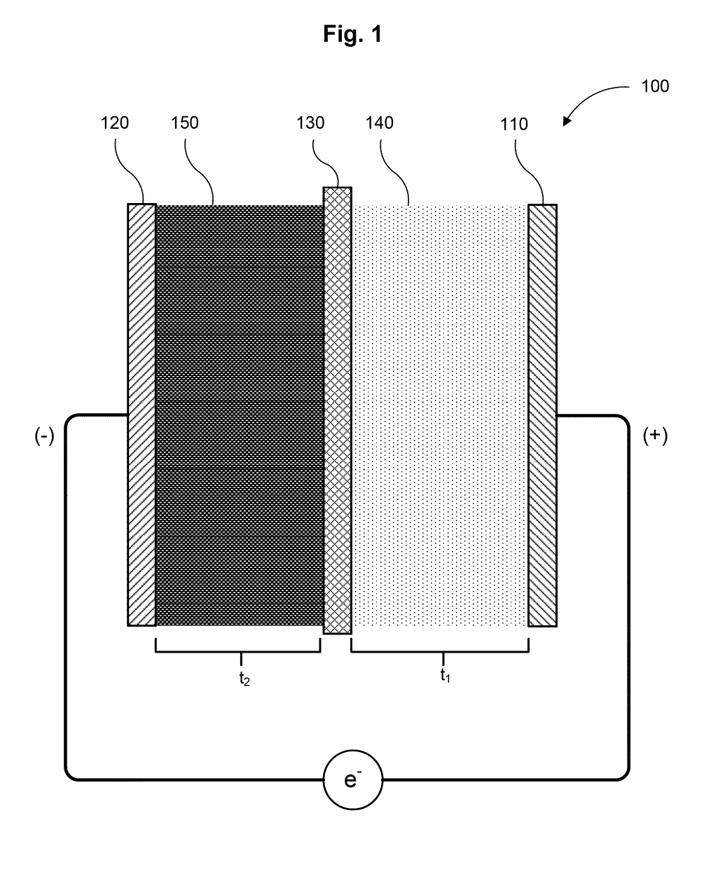

FIG. 1 shows a schematic illustration of an electrochemical cell 100. The electrochemical cell 100 includes a positive current collector 110, a negative current collector 120 and a separator 130 disposed between the positive current collector 110 and the negative current collector 120. The positive current collector 110 is spaced from the separator 130 by a first distance t₁ and at least partially defines a positive electroactive zone. The negative current collector 120 is spaced from the separator 130 by a second distance t₂ and at least partially defines a negative electroactive zone. A semi-solid cathode 140 is disposed in the positive electroactive zone and an anode 150 (e.g., semi-solid anode) is disposed in the negative electroactive zone. In some embodiments, the thickness of the positive electroactive zone defined by the distance t₁ and/or the thickness of the negative electroactive zone defined by the distance t₂ can be in range of about 250 μm to about 2,000 μm.

The semi-solid cathode 140 and/or anode 150 (e.g., semi-solid anode) can be disposed on a current collector, for example, coated, casted, drop coated, pressed, roll pressed, or deposited using any other suitable method. The semi-solid cathode 140 can be disposed on the positive current collector 110 and the anode 150 can be disposed on the negative current collector 120. For example the semi-solid cathode 140 and/or anode 150 (e.g., semi solid anode) can be coated, casted, calendered and/or pressed on the positive current collector 110 and the negative current collector 120, respectively. The positive current collector 110 and the negative current collector 120 can be any current collectors that are electronically conductive and are electrochemically inactive under the operating conditions of the cell. Typical current collectors for lithium cells include copper, stainless steel, or titanium for the negative current collector 120 and aluminum for the positive current collector 110, in the form of sheets or mesh, or any combination thereof.

Current collector materials can be selected to be stable at the operating potentials of the semi-solid cathode 140 and anode 150 (e.g., semi-solid anode) of the electrochemical cell 100. For example, in non-aqueous lithium systems, the positive current collector 110 can include aluminum, or aluminum coated with conductive material that does not electrochemically dissolve at operating potentials of 2.5-5.0 V with respect to Li/Li⁺. Such materials include platinum, gold, conductive metal oxides such as vanadium oxide, and carbon. The negative current collector 120 can include copper or other metals that do not form alloys or intermetallic compounds with lithium, carbon, and/or coatings comprising such materials disposed on another conductor.

The semi-solid cathode 140 and the anode 150 (e.g., semi-solid anode) included in an electrochemical cell can be separated by a separator 130. For example, the separator 130 can be any conventional membrane that is capable of ion transport. In some embodiments, the separator 130 is a liquid impermeable membrane that permits the transport of ions therethrough, namely a solid or gel ionic conductor. In some embodiments the separator 130 is a porous polymer membrane infused with a liquid electrolyte that allows for the shuttling of ions between the semi-solid cathode 140 and the semi-solid anode 150 electroactive materials, while preventing the transfer of electrons. In some embodiments, the separator 130 is a microporous membrane that prevents particles forming the positive and negative electrode compositions from crossing the membrane. In some embodiments, the separator 130 is a single or multilayer microporous separator, optionally with the ability to fuse or “shut down” above a certain temperature so that it no longer transmits working ions, of the type used in the lithium ion battery industry and well-known to those skilled in the art. In some embodiments, the separator 130 can include a polyethyleneoxide (PEO) polymer in which a lithium salt is complexed to provide lithium conductivity, or Nafion™ membranes which are proton conductors. For example, PEO based electrolytes can be used as the separator 130, which is pinhole-free and a solid ionic conductor, optionally stabilized with other membranes such as glass fiber separators as supporting layers. PEO can also be used as a slurry stabilizer, dispersant, etc. in the positive or negative redox compositions. PEO is stable in contact with typical alkyl carbonate-based electrolytes. This can be especially useful in phosphate-based cell chemistries with cell potential at the positive electrode that is less than about 3.6 V with respect to Li metal. The operating temperature of the redox cell can be elevated as necessary to improve the ionic conductivity of the membrane.

The cathode 140 can be a semi-solid stationary cathode. The semi-solid cathode 140 can include an ion-storing solid phase material which can include, for example, an active material and/or a conductive material. The quantity of the ion-storing solid phase material can be in the range of about 10% to about 80% by volume. The cathode 140 can include an active material such as, for example, a lithium bearing compound (e.g., Lithium Iron Phosphate (LFP), LiCoO₂, LiCoO₂ doped with Mg, LiNiO₂, Li(Ni, Co, Al)O₂ (known as “NCA”), Li(Ni, Mn, Co)O₂ (known as “NMC”), LiMn₂O₄ and its derivatives, etc.). The cathode 140 can also include a conductive material such as, for example, graphite, carbon powder, pyrolytic carbon, carbon black, carbon fibers, carbon microfibers, carbon nanotubes (CNTs), single walled CNTs, multi walled CNTs, fullerene carbons including “bucky balls,” graphene sheets and/or aggregate of graphene sheets, any other conductive material, alloys or combination thereof. The cathode 140 can also include a non-aqueous liquid electrolyte comprised of, for example, ethylene carbonate, dimethyl carbonate, diethyl carbonate, ethyl methyl carbonate, propylene carbonate, gamma butyrolactone, acetonitrile, dimethyl ether, or other carbonates or ethers capable of operating between 0 and 5 volts, or any other electrolyte described herein or combination thereof.

In some embodiments, the semi-solid anode 150 includes an ion-storing solid phase material which can include, for example, an active material and/or a conductive material. The quantity of the ion-storing solid phase material can be in the range of about 10% to about 80% by volume. The anode 150 can include an anode active material such as, for example, lithium metal, carbon, lithium-intercalated carbon, graphite, lithium nitrides, lithium alloys and lithium alloy forming compounds of silicon, bismuth, boron, gallium, indium, zinc, tin, tin oxide, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon oxide, silicon carbide, any other materials or alloys thereof, and any other combination thereof.

The anode 150 (e.g., a semi-solid anode) can also include a conductive material which can be a carbonaceous material such as, for example, graphite, carbon powder, pyrolytic carbon, carbon black, carbon fibers, carbon microfibers, carbon nanotubes (CNTs), single walled CNTs, multi walled CNTs, fullerene carbons including “bucky balls”, graphene sheets and/or aggregate of graphene sheets, any other carbonaceous material or combination thereof. In some embodiments, the anode 150 can also include a non-aqueous liquid electrolyte comprised of, for example, ethylene carbonate, dimethyl carbonate, diethyl carbonate, ethyl methyl carbonate, propylene carbonate, gamma butyrolactone, acetonitrile, dimethyl ether, or other carbonates or ethers capable of operating between 0 and 5 volts, or any other electrolyte described herein or combination thereof.

In some embodiments, the semi-solid cathode 140 and/or the semi-solid anode 150 can include active materials and optionally conductive materials in particulate form suspended in a non-aqueous liquid electrolyte. In some embodiments, the semi-solid cathode 140 and/or the semi-solid anode 150 particles (e.g., cathodic or anodic particles) can have an effective diameter of at least about 1 μm. In some embodiments, the cathodic or anodic particles have an effective diameter between about 1 μm and about 10 μm. In other embodiments, the cathodic or anodic particles have an effective diameter of at least about 10 μm or more. In some embodiments, the cathodic or anodic particles have an effective diameter of less than about 1 μm. In other embodiments, the cathodic or anodic particles have an effective diameter of less than about 0.5 μm. In other embodiments, the cathodic or anodic particles have an effective diameter of less than about 0.25 μm. In other embodiments, the cathodic or anodic particles have an effective diameter of less than about 0.1 μm. In other embodiments, the cathodic or anodic particles have an effective diameter of less than about 0.05 μm. In other embodiments, the cathodic or anodic particles have an effective diameter of less than about 0.01 μm.

In some embodiments, the semi-solid cathode 140 includes about 20% to about 80% by volume of an active material. In some embodiments, the semi-solid cathode 140 can include about 40% to about 75% by volume, about 50% to about 75% by volume, about 60% to about 75% by volume, or about 60% to about 80% by volume of an active material.

In some embodiments, the semi-solid cathode 140 can include about 0% to about 25% by volume of a conductive material. In some embodiments, the semi-solid cathode 140 can include about 1% to about 6% by volume, about 6% to about 12% or about 2% to about 15% by volume of a conductive material.

In some embodiments, the semi-solid cathode 140 can include about 20% to about 70% by volume of an electrolyte. In some embodiments, the semi-solid cathode 140 can include about 30% to about 60%, about 40% to about 50%, or about 20% to about 40% by volume of an electrolyte.

In some embodiments, the semi-solid anode 150 can include about 20% to about 80% by volume of an active material. In some embodiments, the semi-solid anode 150 can include about 40% to about 75% by volume, about 50% to about 75%, about 60% to about 75%, or about 60% to about 80% by volume of an active material.

In some embodiments, the semi-solid anode 150 can include about 0% to about 20% by volume of a conductive material. In some embodiments, the semi-solid anode 150 can include about 1% to about 10%, 1% to about 6%, about 0.5% to about 2% by volume, about 2% to about 6%, or about 2% to about 4% by volume of a conductive material.

In some embodiments, the semi-solid anode 150 can include about 20% to about 70% by volume of an electrolyte. In some embodiments, the semi-solid anode 150 can include about 30% to about 60%, about 40% to about 50%, or about 20% to about 40% by volume of an electrolyte.

Examples of active materials, conductive materials, and/or electrolytes that can be used in the semi-solid cathode 140 and/or the semi-solid anode 150 compositions, various formulations thereof, and electrochemical cells formed therefrom, are described in the '159 patent and the '812 application.

In some embodiments, the semi-solid anode 150 can also include about 1% to about 50% by volume of a high capacity material. Such high capacity materials can include, for example, silicon, bismuth, boron, gallium, indium, zinc, tin, antimony, aluminum, titanium oxide, molybdenum, germanium, manganese, niobium, vanadium, tantalum, iron, copper, gold, platinum, chromium, nickel, cobalt, zirconium, yttrium, molybdenum oxide, germanium oxide, silicon oxide, silicon carbide, any other high capacity materials or alloys thereof, and any combination thereof. In some embodiments, the semi-solid anode can include about 1% to about 5% by volume, about 1% to about 10% by volume, or about 1% to about 20% by volume of the high capacity material. Examples of high capacity materials that can be included in the semi-solid anode 150, various formulations thereof and electrochemical cells formed therefrom, are described in the '097 publication.

In some embodiments, at least one of the semi-solid cathode 140 and or the semi-solid anode 150 can include a plurality of engineered meso-pores within the semi-solid electrode, such that the electrode is a porous semi-solid electrode. The plurality of meso-pores can be formed by dispersing a plurality of solid particles within the semi-solid electrode. For example, the solid particles can be added to the semi-solid electrode slurry and dispersed throughout the slurry using any of the mixing processes or equipment described herein. The solid particles can then be dissolved in the semi-solid electrode thereby forming an array of meso-pores within the semi-solid electrode.

In some embodiments, the solid particles can include, for example, ethylene carbonate. Ethylene carbonate is a carbonate ester of ethylene glycol and carbonic acid. Ethylene carbonate is a non-aqueous aprotic electrolyte which is a transparent crystalline solid at about 25 degrees Celsius (i.e., room temperature). Solid ethylene carbonate melts into a liquid at a temperature of greater than about 37 degrees Celsius. Because of its high melting point, ethylene carbonate is commonly used in combination (e.g., about 50% by volume) with other electrolytes that are liquid at about 25 degrees Celsius (e.g., propylene carbonate, dimethyl carbonate, or any other non-aqueous liquid electrolytes) as the non-aqueous liquid electrolyte system for electrodes used in lithium-ion batteries, for example, the semi-solid electrodes described herein.

In some embodiments, the solid particles can include any other compound, polymer, electrolyte, or any combination thereof, that can be a solid at one temperature (e.g., the temperature at which the semi-solid cathode 140 and/or semi-solid anode 150 are manufactured) and be a liquid at another temperature (e.g., the operational temperature of the electrochemical cell 100). In some embodiments, the solid particles can include a compound which can dissolved in a controlled manner, for example, a slower dissolution rate relative to the total processing time required to form the semi-solid electrodes (e.g., by controlling temperature). For example, the solid particles can include electrolytes supplemented with additives, for example, polymers, saturated lipids, any other additives or combination thereof, which can be incorporated into the semi-solid electrodes in solid particulate form and later be dissolved in the semi-solid electrodes to form the meso-pores.

In some embodiments, particles of solid ethylene carbonate are mixed with and dispersed in the semi-solid cathode 140 and/or the semi-solid anode 150 slurry compositions. The solid ethylene carbonate can be mixed with the semi-solid electrode slurry while maintaining the temperature of the semi-solid electrode slurry at lower than about 25 degrees Celsius, for example, about 5 degrees Celsius, such that the solid ethylene carbonate does not melt and/or rapidly dissolve during the mixing process.

The solid particles can be added to the semi-solid cathode 140 and/or the semi-solid anode slurry composition. For example, solid ethylene carbonate can be crushed or powdered to form a plurality of particles such that each particle has a diameter in the range of about 5 μm to about 1,000 μm. For example, each particle can have a diameter in the range of about 5 μm to about 30 μm, about 40 μm to about 60 μm, about 70 μm to about 90 μm, about 100 μm to about 300 μm, about 400 μm to about 600 μm, or about 700 μm to about 1,000 μm, inclusive of all ranges therebetween.

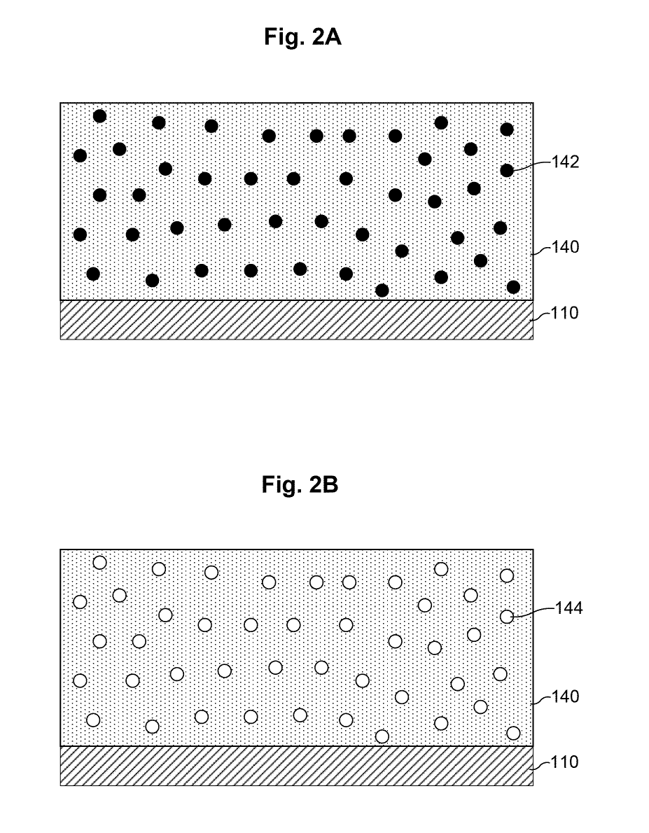

FIG. 2A shows a portion of the semi-solid cathode 140 disposed on the positive current collector 110. The semi-solid cathode 140 includes a plurality of solid particles 142, for example, solid ethylene carbonate dispersed throughout the semi-solid cathode 140. The temperature of the semi-solid cathode 140 can be maintained at a temperature of lower than about 25 degrees Celsius, for example, 5 degrees Celsius such that the solid ethylene carbonate particles 142 do not melt or dissolve on the timescale of mixing. While not shown in FIG. 2A, in some embodiments, the semi-solid anode 150 can also include a quantity of a solid particles 142, for example, the solid ethylene carbonate dispersed within the semi-solid anode 150. In some embodiments, the quantity of the solid particles 142 dispersed in any of the semi-solid cathode 140 and/or semi-solid anode 150 can be in the range of about 5% to about 50% by volume of the electrolyte. For example, in some embodiments, the quantity of solid particles 142 dispersed in the semi-solid cathode 140 and/or semi-solid anode 150 can be in the range of about 5% to about 10%, about 10% to about 15%, about 15% to about 20%, about 20% to about 25%, about 25% to about 30%, about 30% to about 35%, about 35% to about 40%, about 40% to about 45%, or about 45% to about 50% by volume of the liquid electrolyte inclusive of all ranges therebetween. In some embodiments, an appropriate salt, for example, a salt to provide lithium conductivity (e.g., LiClO₄, LiPF₆, LiBF₄, LiTFSI, LiBETI, LiBOB, and the like) can also be included in the solid particles 142.

At the appropriate time, for example, after the electrochemical cell 100 has been assembled, the solid particles 142, for example, ethylene carbonate particles can be dissolved in the semi-solid cathode 140 such that an array of liquid electrolyte filled meso-pores 144 are formed within the semi-solid cathode 140, as shown in FIG. 2B. In some embodiments, the solid particles 142 dissolve in the semi-solid cathode 140 through diffusion. In some embodiments, the semi-solid cathode 140 can be heated, for example, to a temperature of greater than about 37 degrees Celsius. At this temperature, the solid particles 142, for example, ethylene carbonate dissolve such that the semi-solid cathode 140 now includes a plurality of electrolyte filled meso-pores 144 throughout the cross-section of the semi-solid cathode 140 as shown in FIG. 2B. In this manner, an array of controlled diameter electrolyte filled meso-pores 144 is created within the semi-solid cathode 140. The diameter of each of the plurality of meso-pores 144 can be in the range of about 0.01 μm to about 10 μm, which can be defined by the diameter of solid pore-forming particles 142 dispersed in the semi-solid cathode 140 slurry. For example, in some embodiments, each of the plurality of meso-pores 144 can have a diameter in the range of about 5 μm to about 1,000 μm. For example, each meso-pore 144 can have a diameter in the range of about 5 μm to about 30 μm, about 40 μm to about 60 μm, about 70 μm to about 90 μm, about 100 μm to about 300 μm, about 400 μm to about 600 μm, or about 700 μm to about 1,000 μm, inclusive of all ranges therebetween. The semi-solid cathode 140 can include engineered meso-pores in the range of about 5% to about 60% of the total electrode by volume. The volume fraction of meso-pores can be controlled by varying the quantity and size of the solid particles 142 dispersed in the semi-solid cathode 140. These electrolyte filled meso-pores 144 can provide short circuit diffusion paths, which can facilitate fast ion transfer between the active material and the electrolyte, greatly increasing the ionic conductivity of the semi-solid cathode 140 and/or semi-solid anode 150. In some embodiments, the temperature of the semi-solid cathode 140 and/or the semi-solid anode 150 can be raised above the melting point and/or dissolution temperature of the solid particles, for example, ethylene carbonate by providing external heat to the semi-solid electrodes. In some embodiments, the semi-solid electrodes can be formed and packed in place before the solid particles are dissolved to produce the meso-pores. The structure of the semi-solid electrodes can be sufficient to prevent the meso-pores 144 from collapsing. Furthermore, a solid-electrolyte interface (SEI) layer can form in situ after the first charge/discharge cycle that can provide further structural integrity to the meso-pores.

The porous semi-solid electrodes, for example, the semi-solid cathode 140 that includes the plurality of engineered electrolyte filled meso-pores 144, can have a higher conductivity than semi-solid electrodes that do not include the plurality of engineered electrolyte filled meso-pores. In some embodiments, the porous semi-solid electrodes can have a conductivity in the range of about 10⁻² S/cm to about 10 S/cm, for example, about 10⁻¹ S/cm, or about 1 S/cm.

In some embodiments, the cathode 140 can be a semi-solid cathode and the anode 150 can be a conventional anode for example, a solid anode formed from the calendering process as is commonly known in the arts. In some embodiments, the cathode 140 can be a semi-solid cathode and the anode 150 can also be a semi-solid anode as described herein. In some embodiments, each of the semi-solid anode 140 and the semi-solid anode 150 can include a plurality of meso-pores which are formed by dissolving solid particles, for example, ethylene carbonate dispersed in particulate form in the semi-solid cathode 140, and the semi-solid anode 150.

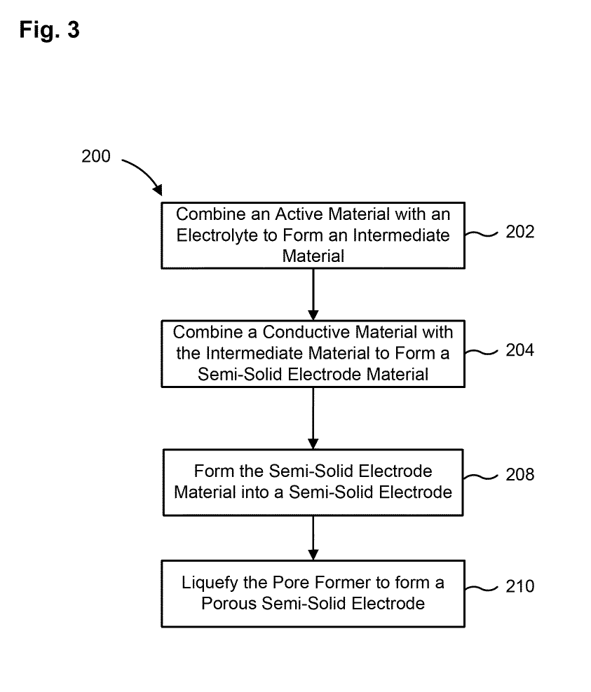

FIG. 3 illustrates a flow diagram showing a method 200 for preparing a porous semi-solid electrode, for example, the semi-solid cathode 140 and/or the semi-solid anode 150 described herein with reference to FIG. 1. The method 200 includes combining an active material with an electrolyte to form an intermediate material 202. The electrolyte includes a liquid component (e.g., a non-aqueous liquid electrolyte component) and a pore former. The active material can include any of the active materials described herein in any suitable concentration range as described herein. The electrolyte can include ethylene carbonate, propylene carbonate, dimethyl carbonate, diethyl carbonate, or any other liquid electrolyte described herein or a combination thereof. In some embodiments, the pore former includes ethylene carbonate. In some embodiments, the pore former includes lithium metal powder. When the pore former of an anode includes lithium metal powder, the lithium metal powder lithiates the anode and leaves behind channels, such that by controlling the particulate size and distribution of the lithium metal powder, a desired pore structure can result. In some embodiments, the pore former is an electrolyte salt. In some embodiments, the pore former includes a polymer that is soluble in the liquid component of the electrolyte (e.g., polyethylene oxide and its derivatives). Such polymers can be electrochemically stable over the range of voltages and temperatures of operation. When the pore former is a polymer, a working time may be defined by kinetics (e.g., rate of dissolution) and/or temperature.

A conductive material is then combined with the intermediate material and mixed to form a semi-solid electrode material 204. The conductive material can be combined and mixed with the semi-solid electrode composition after the active material and the electrolyte are mixed together to form the intermediate material, for example to enable the formation of stable percolation networks, for example, a network of conductive carbon, in the semi-solid electrode material. Stable percolation networks can, for example, enhance the conductivity of the semi-solid electrodes and yield a stable and more flowable semi-solid suspension. In some embodiments, no conductive material is added to the intermediate material, such that mixing of the active material with the electrolyte yields the semi-solid electrode material.

In some embodiments, the pore former comprises a plurality of solid particles, for example solid ethylene carbonate. In some embodiments, each particle included in the plurality of particles can have a diameter in the range of about 5 μm to about 1,000 μm. For example, each particle can have a diameter in the range of about 5 μm to about 30 μm, about 40 μm to about 60 μm, about 70 μm to about 90 μm, about 100 μm to about 300 μm, about 400 μm to about 600 μm, or about 700 μm to about 1,000 μm, inclusive of all ranges therebetween. The quantity of the solid particles can be in the range of about 5% to about 60% by volume of the electrode. For example, in some embodiments, the quantity of solid particles dispersed in the semi-solid cathode 140 and/or semi-solid anode 150 can be in the range of about 5% to about 10%, about 10% to about 15%, about 15% to about 20%, about 20% to about 25%, about 25% to about 30%, about 30% to about 35%, about 35% to about 40%, about 40% to about 45%, or about 45% to about 50%, or about 50% to about 55%, or about 55% to about 60% by volume of the liquid electrolyte inclusive of all ranges therebetween.

The temperature of the semi-solid electrode material can be maintained below the melting point and/or dissolution temperature of the pore former (e.g., ethylene carbonate), for example, lower than about 25 degrees Celsius (e.g., about 5 degrees Celsius), to prevent the pore former from dissolving and/or melting in the semi-solid electrode material. An appropriate salt, for example, a salt to provide lithium conductivity (e.g., LiClO₄, LiPF₆, LiBF₄, LiTFSI, LiBETI, LiBOB, and the like) can also be included in the pore former.

The mixing of the semi-solid electrode material can be performed using any suitable mixing equipment such as, for example, a high shear mixture, a planetary mixture, a centrifugal mixture, a sigma mixture, a CAM mixture and/or a roller mixture. The mixing time and mixing speed are controlled such that a predetermined specific energy is imparted to the semi-solid electrode material. The semi-solid electrode material can be mixed until a relatively stable suspension or slurry forms. Such a stable suspension can have a mixing index of at least about 0.80. In some embodiments, the slurry components can be mixed in a batch process using a batch mixer such as, for example, any of the mixing equipment described herein maintaining a specific spatial and/or temporal ordering of the component addition as described herein. In some embodiments, the slurry components can be mixed in a continuous process (e.g., in an extruder), with a specific spatial and/or temporal ordering of component addition.

In some embodiments, the process conditions can be selected to produce a prepared slurry having an electronic conductivity of at least about 10⁻⁶ S/cm, at least about 10⁻⁵ S/cm, at least about 10⁻⁴ S/cm, at least about 10⁻³ S/cm, at least about 10⁻² S/cm, at least about 10⁻¹ S/cm, at least about 1 S/cm, or at least about 10 S/cm. In some embodiments, the process conditions can be selected to produce a prepared slurry having an apparent viscosity at room temperature of less than about 100,000 Pa-s, less than about 10,000 Pa-s, or less than about 1,000 Pa-s, all at an apparent shear rate of 1,000 s⁻¹. In some embodiments, the process conditions can be selected to produce a prepared slurry having two or more properties as described herein. Examples of mixing equipment that can be used to form the semi-solid electrode suspensions described herein, as well as various mixing parameters are described in the '319 publication.

After the mixing is performed to form the semi-solid electrode material that has the desired electronic and mechanical properties as described herein, the semi-solid electrode material is formed into a semi-solid electrode 208. In some embodiments, the electrode can be a stationary or fixed electrode, for example, the electrode can be calendar roll formed, stamped and/or pressed, subjected to vibrational settling, and/or cut in discrete sections.

After the electrode is formed, the pore former can be liquefied to form the porous semi-solid electrode 210. In some embodiments, the pore former can dissolve into the semi-solid electrode by simple diffusion. In some embodiments, the semi-solid electrode can be heated, for example, to a temperature of greater than about 37 degrees Celsius to dissolve the pore former into the semi-solid electrode to form the porous semi-solid electrode. The porous semi-solid electrode includes an array of electrolyte filled meso-pores which provide a short circuit electronic diffusion path between the electrolyte and the active and/or conductive material included in the semi-solid electrode. The porous semi-solid electrode can, therefore have a higher conductivity than a semi-solid electrode without the array of meso-pores. The porosity of the semi-solid electrode can be varied by varying the quantity and size distribution of the solid particles mixed into the semi-solid electrode material.

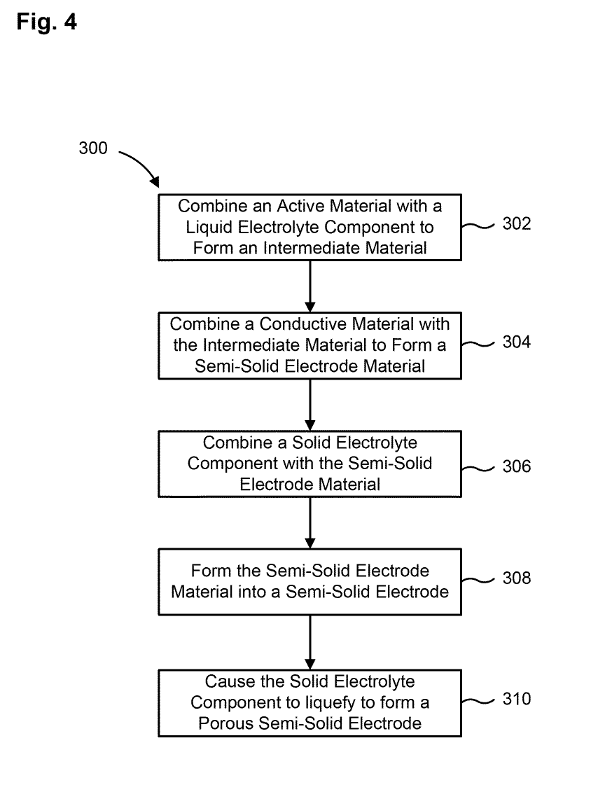

FIG. 4 illustrates a flow diagram showing a method 300 for preparing a porous semi-solid electrode, for example, the semi-solid cathode 140 and/or the semi-solid anode 150 described herein with reference to FIG. 1. The method 300 includes combining an active material with a non-aqueous liquid electrolyte component to form an intermediate material 302. The active material can include any of the active materials described herein in any suitable concentration range as described herein. The non-aqueous liquid electrolyte can include ethylene carbonate, propylene carbonate, dimethyl carbonate, diethyl carbonate, or any other liquid electrolyte described herein or a combination thereof. A conductive material is then combined with the intermediate material and mixed to form a semi-solid electrode material 304. The conductive material can be combined and mixed with the semi-solid electrode composition after the active material and the non-aqueous liquid electrolyte are mixed together to form the intermediate material, for example to enable the formation of stable percolation networks, for example, a network of conductive carbon, in the semi-solid electrode material. Stable percolation networks can, for example, enhance the conductivity of the semi-solid electrodes and yield a stable and more flowable semi-solid suspension. In some embodiments, no conductive material is added to the intermediate material, such that mixing of the active material with the non-aqueous liquid electrolyte yields the semi-solid electrode material.

Next, a solid electrolyte component is combined with the semi-solid electrode material 306. In some embodiments, the solid electrolyte component includes ethylene carbonate. In some embodiments, the solid electrolyte component includes lithium metal powder. When the solid electrolyte component of an anode includes lithium metal powder, the lithium metal powder lithiates the anode and leaves behind channels, such that by controlling the particulate size and distribution of the lithium metal powder, a desired pore structure can result. In some embodiments, the solid electrolyte component is an electrolyte salt. In some embodiments, the solid electrolyte component includes a polymer that is soluble in the liquid component of the electrolyte (e.g., polyethylene oxide and its derivatives). Such polymers can be electrochemically stable over the range of voltages and temperatures of operation. When the solid electrolyte component is a polymer, a working time may be defined by kinetics (e.g., rate of dissolution) and/or temperature. In some embodiments, the solid electrolyte component comprises a plurality of particles, and each particle included in the plurality of particles can have a diameter in the range of about 5 μm to about 1,000 μm. For example, each particle can have a diameter in the range of about 5 μm to about 30 μm, about 40 μm to about 60 μm, about 70 μm to about 90 μm, about 100 μm to about 300 μm, about 400 μm to about 600 μm, or about 700 μm to about 1,000 μm, inclusive of all ranges therebetween. The quantity of the solid particles can be in the range of about 5% to about 60% by volume of the electrode. For example, in some embodiments, the quantity of solid particles dispersed in the semi-solid cathode 140 and/or semi-solid anode 150 can be in the range of about 5% to about 10%, about 10% to about 15%, about 15% to about 20%, about 20% to about 25%, about 25% to about 30%, about 30% to about 35%, about 35% to about 40%, about 40% to about 45%, or about 45% to about 50%, or about 50% to about 55%, or about 55% to about 60% by volume of the liquid electrolyte inclusive of all ranges therebetween. The temperature of the semi-solid electrode material can be maintained below the melting point and/or dissolution temperature of the solid electrolyte component (e.g., ethylene carbonate), for example, lower than about 25 degrees Celsius (e.g., about 5 degrees Celsius), to prevent the solid electrolyte component from dissolving in the semi-solid electrode material. An appropriate salt, for example, a salt to provide lithium conductivity (e.g., LiClO₄, LiPF₆, LiBF₄, LiTFSI, LiBETI, LiBOB, and the like) can also be included in the solid electrolyte component.

The mixing of the semi-solid electrode material can be performed using any suitable mixing equipment such as, for example, a high shear mixture, a planetary mixture, a centrifugal mixture, a sigma mixture, a CAM mixture and/or a roller mixture. The mixing time and mixing speed are controlled such that a predetermined specific energy is imparted to the semi-solid electrode material. The semi-solid electrode material can be mixed until a relatively stable suspension or slurry forms. Such a stable suspension can have a mixing index of at least about 0.80. In some embodiments, the slurry components can be mixed in a batch process using a batch mixer such as, for example, any of the mixing equipment described herein maintaining a specific spatial and/or temporal ordering of the component addition as described herein. In some embodiments, the slurry components can be mixed in a continuous process (e.g., in an extruder), with a specific spatial and/or temporal ordering of component addition.

In some embodiments, the process conditions can be selected to produce a prepared slurry having an electronic conductivity of at least about 10⁻⁶ S/cm, at least about 10⁻⁵ S/cm, at least about 10⁻⁴ S/cm, at least about 10⁻³ S/cm, at least about 10⁻² S/cm, at least about 10⁻¹ S/cm, at least about 1 S/cm, or at least about 10 S/cm. In some embodiments, the process conditions can be selected to produce a prepared slurry having an apparent viscosity at room temperature of less than about 100,000 Pa-s, less than about 10,000 Pa-s, or less than about 1,000 Pa-s, all at an apparent shear rate of 1,000 s⁻¹. In some embodiments, the process conditions can be selected to produce a prepared slurry having two or more properties as described herein. Examples of mixing equipment that can be used to form the semi-solid electrode suspensions described herein, as well as various mixing parameters are described in the '319 publication.

After the mixing is performed to form the semi-solid electrode material that has the desired electronic and mechanical properties as described herein, the semi-solid electrode material is formed into an electrode 308. In some embodiments, the electrode can be a stationary or fixed electrode, for example, the electrode can be calendar roll formed, stamped and/or pressed, subjected to vibrational settling, and/or cut in discrete sections.

After the electrode is formed, the solid particles can dissolve into the semi-solid electrode to form the porous semi-solid electrode 310. In some embodiments, the solid particles can dissolve into the semi-solid electrode by simple diffusion. In some embodiments, the semi-solid electrode can be heated, for example, to a temperature of greater than about 37 degrees Celsius to dissolve the solid particles, into the semi-solid electrode to form the porous semi-solid electrode. The porous semi-solid electrode includes an array of electrolyte filled meso-pores which provide a short circuit electronic diffusion path between the electrolyte and the active and/or conductive material included in the semi-solid electrode. The porous semi-solid electrode can, therefore have a higher conductivity than a semi-solid electrode without the array of meso-pores. The porosity of the semi-solid electrode can be varied by varying the quantity and size distribution of the solid particles mixed into the semi-solid electrode material.

While various embodiments of the system, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the invention. For example, in some embodiments, the active material and the conductive material are combined first, and then the electrolyte is added and mixed. Also, for example, the non-aqueous electrolyte can also include a gel electrolyte. Additionally, certain of the steps may be performed concurrently in a parallel process when possible, as well as performed sequentially as described above. The embodiments have been particularly shown and described, but it will be understood that various changes in form and details may be made.

1. A method of preparing a porous semi-solid electrode, the method comprising:
combining an active material with an electrolyte to form an intermediate material, the electrolyte including a liquid component and a pore former;
combining a conductive material with the intermediate material to form a semi-solid electrode material;
forming the semi-solid electrode material into a semi-solid electrode; and
causing the pore former to liquefy to form a porous semi-solid electrode.

2. The method of claim 1, comprising:
maintaining the pore former at a temperature below a dissolution temperature and/or a melting temperature of the pore former prior to causing the pore former to liquefy.

3. The method of claim 2, wherein the pore former is maintained at a temperature less than about 25 degrees Celsius.

4. The method of claim 1, wherein the pore former is ethylene carbonate (EC).

5. The method of claim 1, wherein the pore former is a polymer.

6. The method of claim 5, wherein the pore former is polyethylene oxide or a derivative thereof.

7. The method of claim 1, wherein the pore former is a salt.

8. The method of claim 1, wherein the pore former is lithium metal powder.

9. The method of claim 1, wherein the pore former comprises a plurality of particles.

10. The method of claim 1, wherein a quantity of the pore former prior to dissolution is in a range of about 5% to about 60% by volume of the electrolyte.

11. The method of claim 1, wherein a quantity of the pore former prior to dissolution is in a range of about 5% to about 60% by volume of the semi-solid electrode.

12. The method of claim 1, wherein the pore former dissolves into the semi-solid electrode via diffusion.

13. The method of claim 1, further comprising:
heating the pore former to dissolve the pore former in the semi-solid electrode to form the porous semi-solid electrode.

14. The method of claim 13, wherein the heating is performed at a temperature of greater than about 37 degrees Celsius.

15. A method of preparing a porous semi-solid electrode, the method comprising:
combining an active material with a liquid electrolyte component to form an intermediate material;
combining a conductive material with the intermediate material to form a semi-solid electrode material;
combining a solid electrolyte component with the semi-solid electrode material;
forming the semi-solid electrode material into a semi-solid electrode; and
causing the solid electrolyte component to liquefy to form a porous semi-solid electrode.

16. The method of claim 15, wherein the solid electrolyte component is combined with the semi-solid electrode material while maintaining the semi-solid electrode material at a temperature of less than about 25 degrees Celsius.

17. The method of claim 15, wherein the solid electrolyte component is combined with the semi-solid electrode material while maintaining the semi-solid electrode material at a temperature below a dissolution temperature and/or a melting temperature of the solid electrolyte component.

18. The method of claim 15, wherein the solid electrolyte component comprises ethylene carbonate (EC).

19. The method of claim 15, wherein the solid electrolyte component is a polymer.

20. The method of claim 19, wherein the solid electrolyte component is polyethylene oxide or a derivative thereof.

21. The method of claim 15, wherein the solid electrolyte component is a salt.

22. The method of claim 15, wherein the solid electrolyte component is lithium metal powder.

23. The method of claim 15, wherein the solid electrolyte component comprises a plurality of particles.

24. The method of claim 15, wherein the solid electrolyte component dissolves in the semi-solid electrode via diffusion.

25. The method of claim 15, the method further comprising heating the solid electrolyte component to dissolve the solid electrolyte component.

26. The method of claim 25, wherein the heating is performed at a temperature of greater than about 37 degrees Celsius.

27. A semi-solid electrode, comprising:
about 20% to about 80% by volume of an active material;
about 0% to about 25% by volume of a conductive material; and
about 20% to about 70% by volume of an electrolyte solution,
the semi-solid electrode including a plurality of pores defined therewithin.

28. The semi-solid electrode of claim 27, wherein the electrolyte solution is disposed within the plurality of pores.

29. The semi-solid electrode of claim 27, wherein each of the plurality of pores provides a diffusion path for fast electron transfer through the semi-solid electrode.

30. The semi-solid electrode of claim 27, wherein the plurality of pores comprises mesopores.
